(19) United States
(12) Patent Application Publication
(10) Pub. No.: US 2026/0258820 A1
(43) Pub. Date: Sep. 3, 2026

(54) INLET HOUSING

(71) Applicant: KYB Corporation, Tokyo (JP)

(72) Inventor: Ryo FUKUSHIMA, Nagano (JP)

(73) Assignee: KYB Corporation, Tokyo (JP)

(21) Appl. No.: 19/163,973

(22) PCT Filed: Feb. 9, 2024
(86) PCT No.: PCT/JP2024/004464

§ 371 Date: Sep. 10, 2025

(30) Foreign Application Priority Data
Mar. 10, 2023 (JP) 2023-037837

(51) Int. Cl. F15B 13/02

(52) U.S. Cl. CPC F15B 13/02

(57) ABSTRACT

An inlet housing (1) includes a port portion (11) for allowing a working fluid to be supplied thereto, the port portion (11) being formed in plurality. The inlet housing (1) comprise a merging portion (13) therein, the merging portion being configured to allow the working fluid from the plurality of port portions (11) to merge.

### TECHNICAL FIELD

The present invention relates to an inlet housing.

### BACKGROUND ART

JP2003-227503 (see, for example, FIG. 3) discloses a hydraulic circuit structure having an end block that allows oil discharged from a main pump to be supplied thereto via a pressure oil supply passage.

### SUMMARY OF INVENTION

In the inlet housing including an inlet port for a working fluid, like the end block described above, a width is determined by a size of the inlet port, which may limit miniaturization.

The present invention has been made in view of such a problem, and an object thereof is to enable miniaturization.

According to one aspect of the present invention, an inlet housing includes a port portion for allowing a working fluid to be supplied thereto, the port portion being formed in plurality, the inlet housing comprising a merging portion therein, the merging portion being configured to allow the working fluid from the plurality of port portions to merge.

### BRIEF DESCRIPTION OF DRAWINGS

FIG. 1 is a schematic configuration diagram of a fluid pressure control device according to an embodiment of the present invention.

FIG. 2 is a top view of an inlet housing according to the embodiment of the present invention.

FIG. 3 is a cross-sectional view of the inlet housing taken along a line A-A in FIG. 2.

FIG. 4 illustrates the inlet housing in the same manner as in FIG. 3 while a joint is assembled.

### DESCRIPTION OF EMBODIMENTS

Hereinafter, embodiments of the present invention will be described with reference to the accompanying drawings.

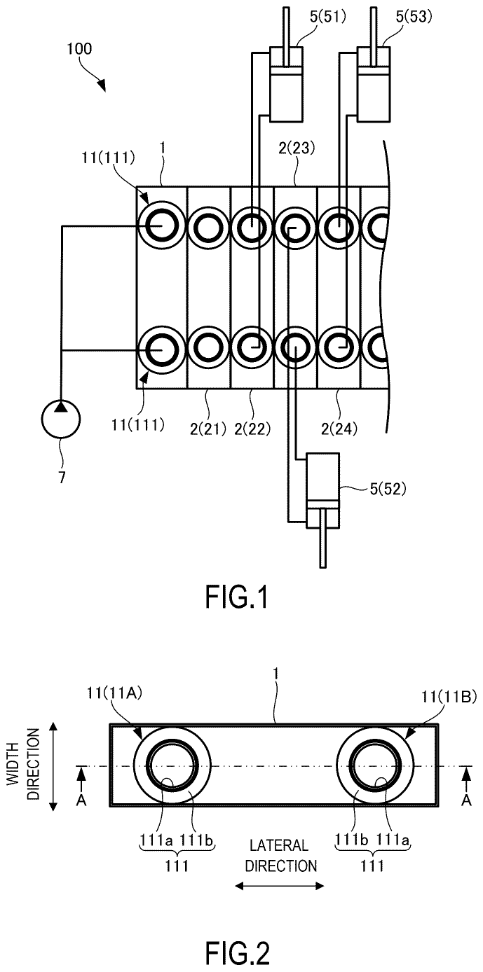

FIG. 1 is a schematic configuration diagram of a fluid pressure control device 100. The fluid pressure control device 100 is used in a construction machine, particularly a hydraulic excavator. The fluid pressure control device 100 includes an inlet housing 1 and a valve housing 2, and a hydraulic cylinder 5 is connected to the valve housing 2 via an oil passage. The fluid pressure control device 100 controls the operation of the hydraulic cylinder 5 by controlling hydraulic oil supplied to or discharged from the hydraulic cylinder 5. A plurality of valve housings 2 and a plurality of hydraulic cylinders 5 are connected to the fluid pressure control device 100. In FIG. 1, a valve housing 21, a valve housing 22, a valve housing 23, and a valve housing 24 are illustrated as the plurality of valve housings 2, and a hydraulic cylinder 51, a hydraulic cylinder 52, and a hydraulic cylinder 53 are illustrated as the plurality of hydraulic cylinders 5.

The valve housing 21 is incorporated as a spare. The hydraulic cylinder 51 is connected to the valve housing 22, the hydraulic cylinder 52 is connected to the valve housing 23, and the hydraulic cylinder 53 is connected to the valve housing 24, via respective oil passages. The plurality of valve housings 2 are stacked together with the inlet housing 1 to form an integrated valve block, thereby forming the fluid pressure control device 100. The plurality of hydraulic cylinders 5 drive, for example, drive targets (not illustrated) such as a boom, an arm, and a bucket of a hydraulic excavator. The hydraulic cylinder 5 corresponds to an actuator, and the hydraulic oil corresponds to a working fluid. The actuator may be a hydraulic motor or the like in addition to the hydraulic cylinder 5. In addition to the hydraulic oil, an incompressible fluid such as water may be used as the working fluid.

The inlet housing 1 is a housing to which hydraulic oil is supplied from an outside of the fluid pressure control device 100, and a control valve for controlling the hydraulic oil is not provided in the inlet housing 1. Therefore, the inlet housing 1 does not control the hydraulic oil supplied to or discharged from the hydraulic cylinder 5. The inlet housing 1 includes a plurality of port portions 11. Although a joint 112 (see FIG. 4) to be described later is not illustrated in FIG. 1 for convenience of illustration, each of the port portions 11 is configured by assembling the joint 112 to an installation portion 111. In the present embodiment, the number of the plurality of port portions 11 is two, but may be three or more.

The hydraulic oil is supplied into the fluid pressure control device 100 via the port portions 11 by a pump 7. An oil passage (pipe) is branched and connected to the port portions 11 from the common pump 7. The oil passage (pipe) from the common pump 7 may be branched by a joint and connected to the port portions 11. Different pumps may be provided for the port portions 11. The hydraulic oil supplied into the inlet housing 1 is supplied to each of the valve housings 2 via an oil passage formed in the valve block. A control valve is provided in the valve housing 2, and the control valve controls the hydraulic oil supplied to or discharged from the corresponding hydraulic cylinder 5.

Next, the inlet housing 1 will be further described.

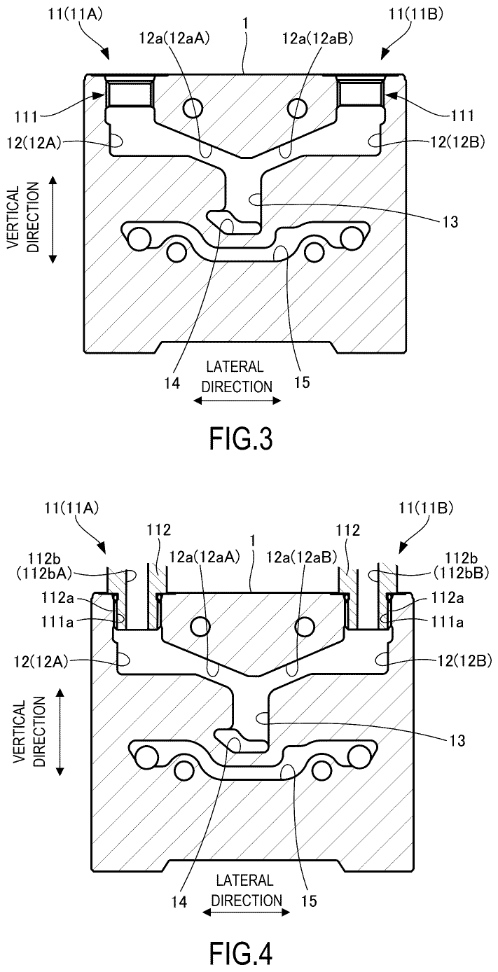

FIG. 2 is a top view of the inlet housing 1. FIG. 3 is a cross-sectional view of the inlet housing 1 taken along a line A-A in FIG. 2. FIG. 4 illustrates the inlet housing 1 in the same manner as in FIG. 3 while the joint 112 is assembled. An up-down direction in FIG. 2 corresponds to a width direction of the inlet housing 1, and a left-right direction in FIG. 2 corresponds to a lateral direction of the inlet housing 1. An up-down direction in FIGS. 3 and 4 corresponds to a vertical direction of the inlet housing 1, and a left-right direction in FIGS. 3 and 4 corresponds to the lateral direction of the inlet housing 1. In FIGS. 2 and 3, similarly to FIG. 1, the joint 112 is not illustrated. Hereinafter, one of two port portions 11 is also referred to as a first port portion 11A, and the other is also referred to as a second port portion 11B.

As illustrated in FIG. 2, the plurality of port portions 11 are arranged side by side in the lateral direction such that center positions thereof in the width direction are the same. The installation portion 111 of each of the port portions 11 has a threaded hole 111a and a counterbore 111b. A female thread is formed in the threaded hole 111a, and the joint 112 is screwed into the threaded hole 111a. Therefore, the joint 112 is attachable to and detachable from each of the plurality of port portions 11, and a seal member is provided in the counterbore 111b.

As illustrated in FIGS. 3 and 4, the joint 112 is assembled to the installation portion 111 in each of the port portions 11. The joint 112 has a tubular shape and includes a threaded portion 112a and a through hole 112b. The threaded portion 112a is formed on an outer periphery of one end of the joint 112. The joint 112 is fixed to the installation portion 111 by fastening the threaded portion 112a to the threaded hole 111a. The through hole 112b penetrates the joint 112 along a central axis of the threaded portion 112a. In a state in which the joint 112 is attached to the port portion 11, the through hole 112b constitutes an inlet port that allows the hydraulic oil to be supplied thereto, and in the port portion 11, the hydraulic oil flows into the inlet housing 1 through the through hole 112b. Therefore, hereinafter, the through hole 112b is also referred to as a port 112b.

The inlet housing 1 includes, as a plurality of ports 112b, a first port 112bA formed in the first port portion 11A and a second port 112bB formed in the second port portion 11B. In the inlet housing 1, each of the plurality of ports 112b extends along the vertical direction. The plurality of port portions 11 may be provided on a surface other than an upper surface of the inlet housing 1 or may not be provided on the same surface.

As illustrated in FIG. 2, a width of the inlet housing 1 is set to be slightly larger than a diameter of the counterbore 111b. Therefore, even if the width of the inlet housing 1 is reduced, the port portion 11 restricts the reduction, and a size of the port portion 11 increases as a size of the port 112b increases.

In view of such circumstances, in the inlet housing 1, the inlet port is divided into a plurality of ports 112b. Accordingly, the size of the port 112b can be reduced as compared with a case of attempting to secure the same flow rate of hydraulic oil through one inlet port as through all of the plurality of ports 112b. As a result, the size of the inlet housing 1 can be reduced. Further, it is also possible to downsize the fluid pressure control device 100 through miniaturization of the inlet housing 1.

As illustrated in FIGS. 3 and 4, the inlet housing 1 includes a plurality of internal passages 12, a merging portion 13, and a discharge passage 14, and additionally, includes a tank passage 15. The tank passage 15 is a passage communicating with a tank storing the hydraulic oil. The hydraulic oil discharged from the pump 7 is supplied into the inlet housing 1 through the port 112b and then supplied to the valve housing 2.

The internal passage 12 allows the plurality of ports 112b, in other words, the through holes 112b as the inlet ports attached to the plurality of port portions 11, to communicate with the merging portion 13. Therefore, the inlet housing 1 has the same number of internal passages 12 as the plurality of ports 112b. The plurality of internal passages 12 include a first internal passage 12A communicating with the first port 112bA and a second internal passage 12B communicating with the second port 112bB. The first internal passage 12A and the second internal passage 12B both extend inward in the vertical direction from the corresponding ports 112b, then extend inward in the lateral direction, and communicate with the merging portion 13. The first internal passage 12A and the second internal passage 12B are formed to be substantially symmetrical to each other in the lateral direction about the merging portion 13.

Each of the internal passages 12 has a minimum passage portion 12a. The first internal passage 12A has a first minimum passage portion 12aA as the minimum passage portion 12a, and the second internal passage 12B has a second minimum passage portion 12aB as the minimum passage portion 12a. The first minimum passage portion 12aA is a portion of the first internal passage 12A having a passage narrower than the other portions, that is, a portion having a smallest passage cross-sectional area. The first minimum passage portion 12aA is provided at an end portion of the first internal passage 12A on a side communicating with the merging portion 13. The first minimum passage portion 12aA may be provided in a portion other than the end portion in the first internal passage 12A. The same applies to the second minimum passage portion 12aB and the second internal passage 12B.

In the inlet housing 1, the passage of the first port 112bA is narrower than the first minimum passage portion 12aA, and the passage of the second port 112bB is narrower than the second minimum passage portion 12aB. That is, the port 112b has a passage cross-sectional area smaller than a minimum passage cross-sectional area of the corresponding internal passage 12. In other words, a passage cross-sectional area of the minimum passage portion 12a having the narrowest passage in the internal passages 12 corresponding to the plurality of ports 112b is larger than the passage cross-sectional area of the port 112b. Accordingly, since the flow rate of the hydraulic oil flowing in from the plurality of ports 112b can be prevented from being restricted by the plurality of internal passages 12, the occurrence of a pressure loss is prevented. As a result, the pressure loss in the inlet housing 1 is reduced.

The merging portion 13 is a portion that allows the hydraulic oil from the plurality of ports 112b to merge, and is formed in the inlet housing 1. The merging portion 13 is provided substantially at a center of the inlet housing 1 and extends along the vertical direction (accordingly, an extending direction of the port 112b). The first internal passage 12A and the second internal passage 12B as the plurality of internal passages 12 communicate with the merging portion 13. The first internal passage 12A and the second internal passage 12B communicate with the merging portion 13 on a downstream side.

The merging portion 13 has a passage cross-sectional area larger than a sum of minimum passage cross-sectional areas of the first internal passage 12A and the second internal passage 12B, in other words, a total passage cross-sectional area of the minimum passage portions 12a having the narrowest passage in the plurality of internal passages 12. Accordingly, since the flow rate of the working fluid flowing in from the first internal passage 12A and the second internal passage 12B can be prevented from being restricted by the merging portion 13, the occurrence of a pressure loss is prevented. As a result, the pressure loss in the inlet housing 1 is reduced.

The hydraulic oil from the first internal passage 12A and the second internal passage 12B merges upstream of the merging portion 13 and flows downstream. In the merging portion 13, the hydraulic oil from the first internal passage 12A and the second internal passage 12B merges without passing through the valve housing 2. That is, the hydraulic oil from the first internal passage 12A and the second internal passage 12B immediately merges at the merging portion 13 without passing through the control valve provided in the valve housing 2. In other words, the control valve is not involved in the connection between the first internal passage 12A and the second internal passage 12B and the merging portion 13, and the first internal passage 12A and the second internal passage 12B are constantly in communication with the merging portion 13.

The merging portion 13 communicates with the discharge passage 14 at a downstream end. The discharge passage 14 allows the merging portion 13 to communicate with an outside of the inlet housing 1. The discharge passage 14 extends from the merging portion 13 toward a side where the plurality of valve housings 2 in the width direction (direction orthogonal to the paper surface in FIGS. 3 and 4) are provided, and opens to the outside of the inlet housing 1. The discharge passage 14 is connected to the valve housing 2 disposed adjacent to the inlet housing 1, that is, an oil passage formed in the valve housing 21.

In this way, the inlet housing 1 merges the supplied hydraulic oil and discharges the merged hydraulic oil to the outside of the inlet housing 1. In the inlet housing 1, the hydraulic oil does not pass through the valve housing 2 before the hydraulic oil is supplied into the inlet housing 1 and then is discharged to the outside of the inlet housing 1. That is, the inlet housing 1 is configured as a housing specialized for receiving the hydraulic oil in the fluid pressure control device 100 that controls the hydraulic oil, so to speak, a housing dedicated to receiving the hydraulic oil. In the inlet housing 1, the corresponding port 112b has the smallest passage cross-sectional area in flow paths of the hydraulic oil from the ports 112b to the discharge passage 14. Therefore, the corresponding port 112b has a dominant influence on the flow rate of the hydraulic oil flowing through each of the flow paths.

Hereinafter, configurations, functions, and effects of the embodiment of the present invention will be collectively described.

The inlet housing 1 has a plurality of port portions 11 that allow hydraulic oil to be supplied thereto, and has therein the merging portion 13 that allows the hydraulic oil from the plurality of port portions 11 to merge.

With this configuration, a single port portion is divided into the plurality of port portions 11, so to speak. Therefore, when the same flow rate of hydraulic oil is ensured, a size of each of the port portions 11 can be made smaller than in the case of the single port portion. As a result, a width of the inlet housing 1 can be reduced.

The joint 112 in which the port 112b to which the hydraulic oil is supplied is formed is attachable to and detachable from each of the plurality of port portions 11, and the inlet housing 1 includes a plurality of internal passages 12 that allow the ports 112b attached to the plurality of port portions 11 to communicate with the merging portion 13. The passage cross-sectional area of the minimum passage portion 12a having the narrowest passage in the internal passages 12 corresponding to the plurality of ports 112b is larger than the passage cross-sectional area of the port 112b.

With this configuration, since the flow rate of the hydraulic oil flowing in from the plurality of ports 112b is not restricted by the plurality of internal passages 12, the occurrence of the pressure loss can be prevented, and thus the pressure loss in the inlet housing 1 can be reduced.

The inlet housing 1 includes the plurality of internal passages 12 that allow the plurality of port portions 11 to communicate with the merging portion 13. The merging portion 13 has a passage cross-sectional area larger than a total passage cross-sectional area of the minimum passage portions 12a having the narrowest passage in the plurality of internal passages 12.

With this configuration, since the flow rate of the working fluid flowing in from the plurality of internal passages 12 is not restricted by the merging portion 13, the occurrence of the pressure loss can be prevented, and thus the pressure loss in the inlet housing 1 can be reduced.

This application claims priority based on Japanese Patent Application No.2023-037837 filed with the Japan Patent Office on Mar. 10, 2023, the entire contents of which are incorporated into this specification.

1. An inlet housing including a port portion for allowing a working fluid to be supplied thereto,
the port portion being formed in plurality,
the inlet housing comprising a merging portion therein, the merging portion being configured to allow the working fluid from the plurality of port portions to merge.

2. The inlet housing according to claim 1, wherein
a joint in which an inlet port to which the working fluid is supplied is formed is attachable to and detachable from each of the plurality of port portions,
the inlet housing further comprises a plurality of internal passages configured to allow inlet ports attached to the plurality of port portions to communicate with the merging portion, and
a passage cross-sectional area of a minimum passage portion having a narrowest passage in the internal passages corresponding to a plurality of the inlet ports is larger than a passage cross-sectional area of the inlet port.

3. The inlet housing according to claim 1, further comprising:
a plurality of internal passages configured to allow the plurality of port portions to communicate with the merging portion, wherein
the merging portion has a passage cross-sectional area larger than a total passage cross-sectional area of minimum passage portions having a narrowest passage in the plurality of internal passages.
